(19) United States
(12) Patent Application Publication
(10) Pub. No.: US 2009/0170209 A1
(43) Pub. Date: Jul. 2, 2009

(54) HYDROGEL CHEMICAL SENSOR

(75) Inventors: Andrew Machauf, Wardon (IL); Ariel Cohen, Givat Yearin (IL); IIan Levy, Harif (IL)

Correspondence Address: COOL PATENT, P.C.;c/o CPA Global, P.O. BOX 52050, MINNEAPOLIS, MN, 55402, US

(73) Assignee: Music Germlin, Inc

(21) Appl. No.: 11/967,140

(22) Filed: Dec. 29, 2007

(51) Int. Cl. G01N 31/00

(52) U.S. Cl. 436/148; 257/414

(57) ABSTRACT

An apparatus and method for detecting an analyte wherein a member may respond to mechanical stress induced by a volume change of a sensitive hydrogel upon sensing an analyte and wherein the mechanical stress may be detected by a detector.

### BACKGROUND

Field of the Invention: The present invention relates to a chemical sensor device using a solid-state sensor. Detection of analytes and analyte concentrations is critical in a number of fields including medicine, pharmaceutical research, and environmental science. Solid-state sensors may be used for detection of a variety of analytes, such as: acid, base, organic/inorganic chemicals, and/or biomolecules. In a particular embodiment, a chemical sensor may comprise a recognition element and a transducing structure capable of converting the molecular recognition event into a quantifiable signal. Accordingly, a variety of devices may serve as chemical sensors, such as, piezoelectric sensors, piezoresistive sensors, piezomagnetic sensors, field effect devices with the gate area being the sensing region, field effect transistors (FET) comprising devices with biological species for detecting biomolecular analyte disposed directly on the cantilever, and capacitive sensing devices.

### BRIEF DESCRIPTION OF THE DRAWINGS

FIG. 1 is a diagram of a particular embodiment of a biosensor for detecting the presence of an analyte in a sample.

FIG. 2 is a diagram of a particular embodiment of a biosensor for detecting the presence of an analyte in a sample.

FIG. 3 is a diagram of a particular embodiment of a biosensor for detecting the presence of an analyte.

FIG. 4 is a diagram of a particular embodiment of a biosensor for detecting the presence of an analyte.

FIG. 5 is a block diagram illustrating a process for detecting the presence of an analyte in a sample.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Throughout the following disclosure the term ‘hydrogel’ is used and is intended to refer to a polymeric material responsive to a variety of stimuli, such as, for instance, biomolecules, humidity, pH, temperature, electric field, light, and ion strength. In particular applications, the volume of hydrogels may change in response to specific stimuli. Throughout the following disclosure the term ‘biosensor’ is used and is intended to refer to a device capable of detection of an analyte that combines a biological component with a detector element. The terms ‘biomolecule’ and ‘biomolecular’ are used throughout the following disclosure and are intended to refer to one or more molecules that naturally occur in living organisms. The term ‘analyte’ is used throughout the following disclosure and is intended to refer to any chemical or biological constituent that is undergoing analysis. The term ‘probe’ is used throughout the following disclosure and is intended to refer to any identifiable substance that may be used to detect, isolate, or identify another substance.

Throughout the following disclosure particular embodiments of a solid-state chemical sensor are disclosed. For the purpose of clarity, biomolecular sensors for detecting analytes comprising various species of biomolecules are discussed. However, the device and method disclosed herein may be useful for detecting many varieties of organic and inorganic chemicals and compounds and claimed subject matter is not limited in this regard.

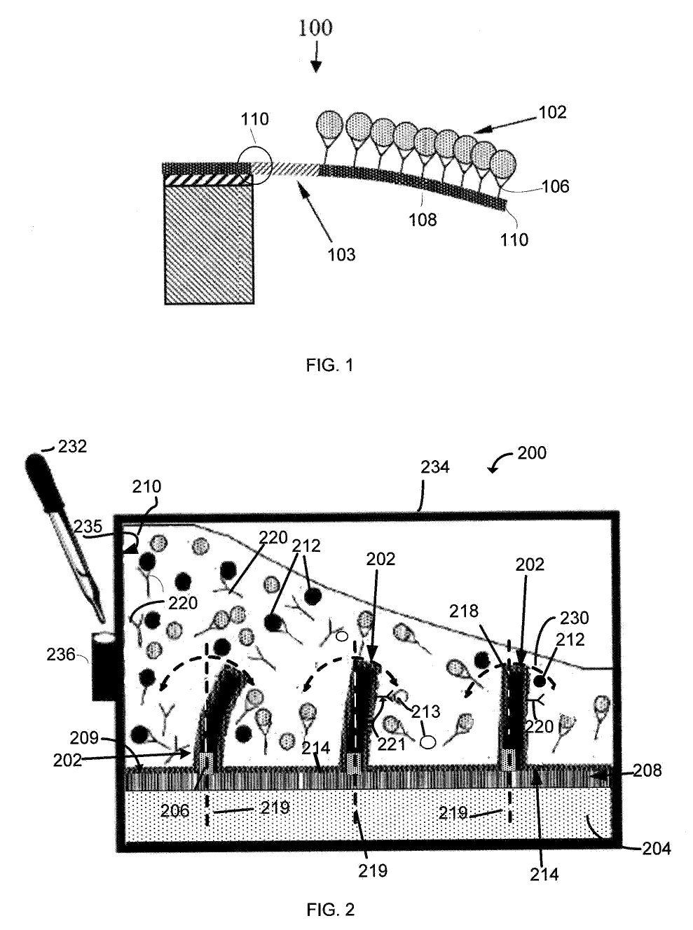

FIG. 1 depicts a particular embodiment of a solid-state biosensor 100 for detecting a biomolecular analyte 102. In a particular embodiment, biosensor 100 may comprise an embedded field effect transistor (FET) 103. According to a particular embodiment, one or more biomolecular probes 106 may be embedded directly on an outside surface of cantilever 108. According to a particular embodiment, upon detection of biomolecular analyte 102, cantilever 108 may exert mechanical stress on FET 103 due to steric and/or electrostatic forces brought on by binding of probes 106 with biomolecular analytes 102. In a particular embodiment, steric stress resulting from attachment of biomolecular analyte 102 on cantilever 108 may deflect cantilever tip 110. In another particular embodiment, a biosensor (not shown) may comprise a Field Effect Transistor (FET) capable of detecting a biomolecular analyte using a gate comprising biomolecular probes. According to a particular embodiment, the gate probes may be capable of reacting with the biomolecular analyte. Detection may occur upon a change in the status of the gate induced by reaction with the biomolecular analyte.

FIG. 2 illustrates a biosensor 200 capable of detecting an analyte 212 from sample 232. In a particular embodiment, the sample may be in solid, liquid and/or gas phase. Member 202 may have an initial position 218 substantially parallel to axis 219 and may be coupled to detector 206. Member 202 may also be disposed on substrate 204. According to a particular embodiment, member 202 and surface 208 of substrate 204 may be sealed with coating 214 that may be substantially impermeable to a variety of substances in a variety of physical phases and claimed subject matter is not so limited. Coating 214 may comprise any of a variety of materials, such as, polyimde, wax and/or gum and claimed subject matter is not limited in this regard. Such a coating may enable biosensor 200 to: be immersed in a liquid or gas sample, be used repeatedly while resisting wear and reduce device failure. However, this is merely an example of a method of assembling a biosensor and claimed subject matter is not so limited.

In a particular embodiment, member 202 may have a high aspect ratio and may comprise a variety of structures, such as, for instance a: cantilever, blade, cylinder and/or nanowire and claimed subject matter is not limited in this regard. According to a particular embodiment, member 202 may comprise a variety of materials such as, for instance; quartz crystal, ceramic, silicon, silicon-oxide, gallium arsenide, silicon germanium, silicon carbide, gallium phosphide and/or polysilicon and claimed subject matter is not limited in this regard. In a particular embodiment, substrate 204 may comprise of a variety of materials, such as, for instance: silicon, silicon-oxide, gallium arsenide, silicon germanium, silicon carbide, gallium phosphide and/or polysilicon and claimed subject matter is not so limited.

According to a particular embodiment, detector 206 may be capable of detecting mechanical stress in member 202 induced by a volume change in hydrogel 210. Such volume change may be induced when hydrogel 210 reacts with analyte 212 when exposed to sample 232. In conventional solid state sensor detection methods, often electrical drift and low S/N ratio have a negative impact on accuracy as the sensing device typically is completely isolated from the analyte solution. Here, however, a sample may be directly in contact with member 202 and hydrogel 210. This may enable greater sensitivity than conventional methods, as hydrogel 210 may generate very large forces and member 202 may have high sensitivity to mechanical stress.

According to a particular embodiment, detector 206 may be disposed between member 202 and surface 208. In another particular embodiment, detector 206 may be embedded within member 202 and/or substrate 204. According to a particular embodiment, detector 206 may comprise any of a variety of devices capable of detecting mechanical stress in member 202. Detection of mechanical stress may be registered in a variety of ways such as: stress induced modulation of channel conductivity and eventually the transistor drain current in a FET and/or stress induced generation of an electric potential in a piezoelectric device and claimed subject matter is not limited in this regard. According to a particular embodiment, detection of mechanical stress indicates the presence of analyte 212 in sample 232. In a particular embodiment, detector 206 may comprise a variety of devices, such as, for instance a: field effect transistor, piezoelectric detector, piezoresistive detector, piezomagnetic detector, metal-oxide semiconductor field effect transistor, polysilicon-oxide semiconductor field effect transistor and/or vertical integrated silicon nanowire field effect transistors and claimed subject matter is not so limited. In a particular embodiment, detector 206 may be capable of communicating detection of mechanical stress to an information processing system such as an on-chip electronic circuit for processing and/or a computer and claimed subject matter is not limited in this regard.

In a particular embodiment, biosensor 200 may be fabricated in a variety of dimensions, such as, microscale or nanoscale fabrication and claimed subject matter is not limited in this regard. For instance, in a particular embodiment, member 202 may be 1000 nm×5000 nm 10000 nm and substrate 204 may be 500 μm×2000 μm×2000 μm. Additionally, biosensor 200 may be fabricated in Silicon on Insulator (SOI) technology. For instance, in an SOI device an upper silicon layer may comprise member 202 and may be electrically isolated from the substrate 204 by the oxide layer which could facilitate manufacturability and improve sensitivity.

In a particular embodiment, member 202 may be in contact with hydrogel 210. Hydrogel 210 may comprise a polymer network and may be sensitive to analyte 212. According to a particular embodiment, analyte 212 may comprise any of a variety of biological species and/or other chemical species of interest such as; acid, base, organic chemicals, inorganic chemicals and/or biomolecules and claimed subject matter is not limited in this regard. In a particular embodiment, hydrogel 210 may be capable of inducing mechanical stress in member 202 by inducing a deflection from initial position 218 to a second position. Such deflection depends on a variety of factors, such as member 202 dimensions and composition, analyte, solution, temperature, pressure and so on. In a particular embodiment, arc 230 illustrates a deflection path member 202 may follow if analyte 212 is sensed by hydrogel 210.

In a particular embodiment, hydrogel 210 may comprise one or more biomolecular probes 220 coupled to the polymer network of hydrogel 210 and one or more biomolecules 222 coupled to the polymer network of hydrogel 210. In a particular embodiment, binding between biomolecular probes 220 and biomolecules 222 may be by non-covalent cross-linking within the polymer network of hydrogel 210.

According to a particular embodiment, biomolecules 222 may be the same or similar to analyte 212 and if hydrogel 210 is exposed to analyte 212, analyte 212 competes with biomolecule 222 for non-covalent crosslinking with biomolecular probe 220 wherein such competitive non-covalent crosslinking between the biomolecular probe and analyte 212 may induce a volume change in the hydrogel 210 which may then induce a deflection of member 202 from an initial position 218.

In a particular embodiment, biochemical sensor 200 may further comprise one or more biomolecular probes 220 coupled to an outside surface of member 202 wherein the one or more biomolecular probes are capable of chemically bonding to analyte 212 and thereby inducing mechanical stress on member 202 due to steric and/or electrochemical effects of bonding. In another particular embodiment a second biomolecular probe 221 may be coupled to member 202 and may be capable of detecting and binding to a second analyte 213 to enable detection of different analytes in the same sample 232.

In a particular embodiment, biomolecular probe 220 and 221 may comprise a variety of biomolecular species, such as: antibodies, antibody fragments, single-chain antibodies, genetically engineered antibodies, oligonucleotides, polynucleotides, nucleicacids, nucleic acid analogues, peptide nucleic acids, proteins, peptides, binding proteins, receptor proteins, transport proteins, lectins, substrates, inhibitors, activators, ligands, hormones, neurotranamitters, growth factors and/or cytokines and claimed subject matter is not limited in this regard.

In a particular embodiment, biomolecules 222, analytes 212 and 213 may comprise a variety of biomolecular species, such as: amino acid, peptide, polypeptide, protein, glycoprotein, lipoprotein, antibody, nucleoside, nucleotide, oligonucleotide, nucleic acid, sugar, carbohydrate, oligosaccharide, polysaccharide, fatty acid, lipid, hormone, metabolite, growth factor, cytokine, chemokine, receptor, neurotransmitter, antigen, allergen, antibody, substrate, metabolite, cofactor, inhibitor, drug, pharmaceutical, nutrient, biohazardous agent, infectious agent, prion, vitamin, heterocyclic aromatic compound, carcinogen, mutagen, waste product, virus, bacterium, Salmonella, Streptococcus, Legionella, E. coli, Giardia, Cryptosporidium, Rickettsia, spore, mold, yeast, algae, amoebae, dinoflagellate, unicellular organism, pathogen, prion and/or a cell and claimed subject matter is not limited in this regard.

In a particular embodiment, hydrogel 210 may be exposed to sample 232 by a variety of methods, such as, for instance, by titrating an aqueous sample 232 containing analyte 212 directly onto a particular portion of hydrogel 210 or by exposing a portion of hydrogel 210 to a gas carrier containing analyte 212 and claimed subject matter is not limited in this regard. In a particular embodiment, biosensor 200 may be enclosed in package 234 wherein package 234 may limit exposure to sample 232 to only a portion of hydrogel 210. The package 234 may be configured in a variety of ways and claimed subject matter is not limited in this regard. For instance, in a particular embodiment, package 234 may have an opening on one end or comprise port 236 for receiving sample 232. Limiting sample 232 exposure to a portion of hydrogel 210 may enable establishing a local diffusion gradient of analyte 212. Such a diffusion gradient may induce a gradual volume change in hydrogel 210. Such gradual volume change may induce mechanical stress in member 202 such as by deflecting member 202 from an initial position 218. Desorption of analyte 212 from hydrogel 210 may enable hydrogel 210 to return to its initial volume and consequently return member 202 to its initial position 218 thus enabling multiple usage of the same device.

In a particular embodiment, hydrogel 210 may be chemically coupled to substrate 204, outer surface 209 of substrate 208 on top of coating 214 and/or inside surface 235 of package 234. Coupling hydrogel 210 to substrate 204, top surface 209 and/or inside surface 235 may be done in a variety of ways. In a particular embodiment, such coupling may be facilitated by a cross-linking agent wherein such cross-linking agent comprises a first layer of polyglycidyl methacrylate (PGMA) partially modified with acrylic acid. In a particular embodiment, PGMA may be coupled to surface 209 or alternatively it may be coupled directly to a surface of substrate 204. According to a particular embodiment, a second layer of polyacrylamide gel (PAAG) may be coupled to substrate 204 or surface 209 via PGMA by photo or thermo initiated in situ radical copolymerization of acrylamide and N,N′-methylene-bisacrylamide thereby coupling hydrogel 210 to substrate 204, surface 209 and/or inside surface 235. However, this is merely an example of a method of coupling a hydrogel to a surface and claimed subject matter is not so limited.

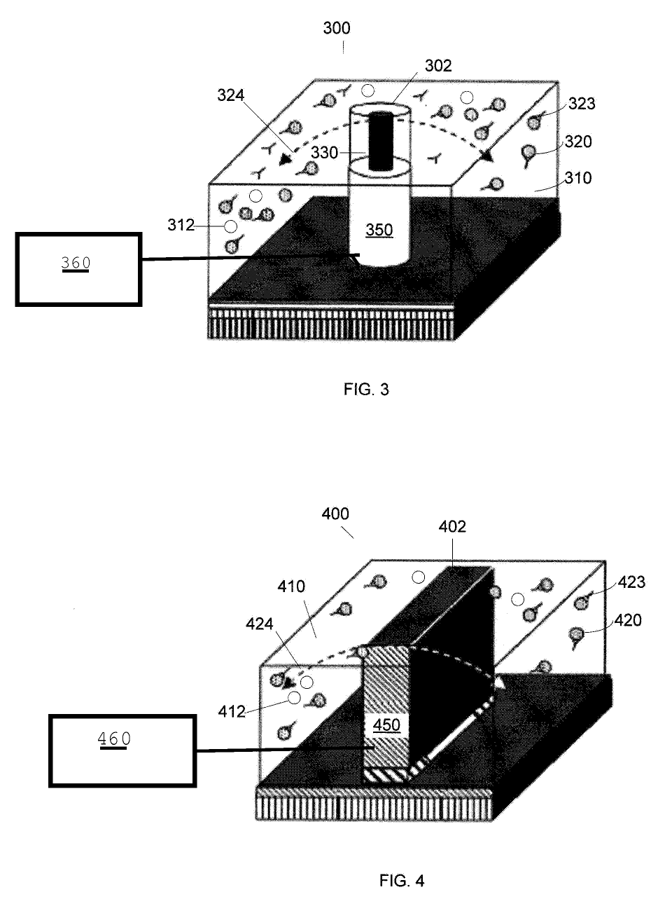

FIG. 3 illustrates a particular embodiment of a biosensor 300 for detecting analyte 312. In a particular embodiment, biosensor 300 may be immersed in hydrogel 310. Hydrogel 310 may comprise biomolecular probe 323 and biomolecule 320. In a particular embodiment, biosensor 300 may comprise a detector 350. Detector 350 may be cylindrical and operate as a field effect transistor capable of detecting analyte 312. In a particular embodiment, member 302 may comprise a vertical nanowire 330 capable of deflecting in response to mechanical stress. Nanowire 330 may comprise a variety of materials such as silicon or other semiconductor materials. In a particular embodiment, before introduction of analyte 312 biomolecules 320 and biomolecular probes 323 may be cross-linked and are dispersed throughout the polymer matrix of hydrogel 310. According to a particular embodiment, when analyte 312 is present it may compete for cross-linking bonds to biomolecular probe 323 which may induce a volume change in hydrogel 310. According to a particular embodiment, if hydrogel 310 reacts with analyte 312 and undergoes a volume change, member 302 may deflect along arc 324 in response to mechanical stress induced by a volume change of hydrogel 310. Such deflection may register with detector 350. In a particular embodiment, detector 350 may be capable of communicating detection of mechanical stress to an information processing system 360 such as an on-chip electronic circuit for processing and/or a computer and claimed subject matter is not limited in this regard. However, this is merely an example of a biosensor comprising a vertical nanowire field effect transistor and claimed subject matter is not so limited.

FIG. 4 illustrates a particular embodiment of a biosensor 400 for detecting analyte 412. In a particular embodiment, biosensor 400 may be immersed in hydrogel 410. Biosensor 400 may comprise a detector 450. Detector 450 may have a blade shape and may operate as a field effect transistor capable of detecting analyte 412. In a particular embodiment, as discussed above member 402 may comprise a variety of materials and may be capable of deflecting in response to mechanical stress. In a particular embodiment, before introduction of analyte 412 biomolecules 420 and biomolecular probes 423 may be cross-linked and are dispersed throughout the polymer matrix of hydrogel 410. According to a particular embodiment, when analyte 412 is present it may compete for cross-linking bonds to biomolecular probe 423 which may induce a volume change in hydrogel 410. According to a particular embodiment, if hydrogel 410 reacts with analyte 412 and undergoes a volume change, member 402 may deflect along arc 424 in response to mechanical stress induced by a volume change of hydrogel 410. Such deflection may register with detector 450. In a particular embodiment, detector 350 may be capable of communicating detection of mechanical stress to an information processing system 460 such as an on-chip electronic circuit for processing and/or a computer and claimed subject matter is not limited in this regard. However, this is merely an example of a biosensor comprising a blade shaped field effect transistor and claimed subject matter is not so limited.

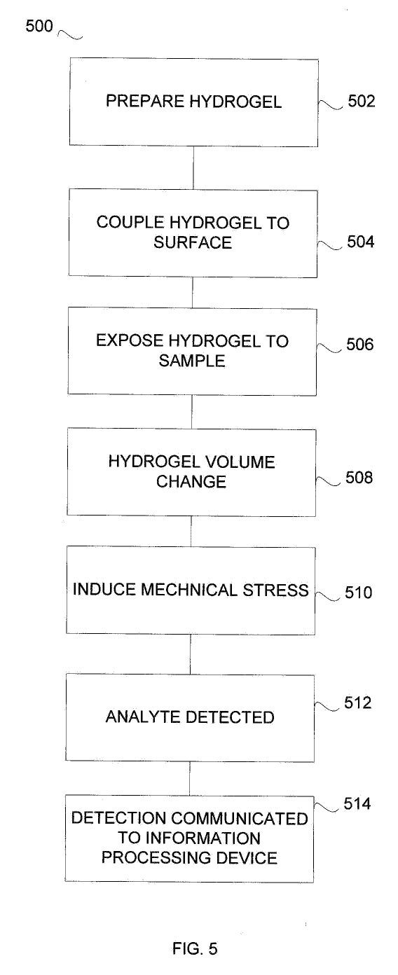

FIG. 5 is a block diagram illustrating a method 500 for detecting an analyte. At block 502, a hydrogel is prepared such that the hydrogel may be sensitive to an analyte and wherein the hydrogel may exhibit a volume change upon exposure to the analyte. At block 504, the hydrogel may be coupled to a substrate wherein the substrate is physically coupled to a member for detecting the analyte. At block 506, the hydrogel is exposed to a sample containing the analyte. At block 508, the hydrogel undergoes a volume change. In a particular embodiment, the volume change may be proportional to a diffusion gradient of the analyte into the hydrogel. At block 510, the hydrogel induces mechanical stress on the member. At block 512, the member detects the presence of the analyte based at least in part on detection of mechanical stress in the member. At block 514, detection of the analyte is registered by an information processing system such as an on-chip electronic circuit for processing and/or a computer.

While certain features of claimed subject matter have been illustrated as described herein, many modifications, substitutions, changes and equivalents will now occur to those skilled in the art. It is, therefore, to be understood that the appended claims are intended to cover all such embodiments and changes as fall within the spirit of claimed subject matter.

1. An apparatus for detecting an analyte comprising:
a member, the member having an initial position wherein the member comprises a: blade, cylinder or nanowire, or combinations thereof;
a substrate, wherein the member is coupled to the substrate and extends from a top surface of the substrate and wherein the initial position of the member is any angle between 0 to 180 degrees with respect to the top surface of the substrate;
a hydrogel comprising a polymer network in contact with the member, the hydrogel being sensitive to a first analyte, the hydrogel being capable of inducing a deflection of the member from the initial position if the first analyte reacts with one or more constituents of the hydrogel, wherein the member is immersed in the hydrogel; and
a detector coupled to the member, the detector capable of detecting mechanical stress in the member and further capable of communicating detection of mechanical stress to an information processing system.

2. The apparatus of claim 1, wherein the detector comprises: field effect transistors, metal-oxide semiconductor field effect transistors, polysilicon-oxide semiconductor field effect transistors, vertical integrated silicon nanowire field effect transistors, piezoelectric detectors, piezoresistive detectors or piezomagnetic detectors, or combinations thereof.

3. The apparatus of claim 1, further comprising one or more biomolecular probes coupled to the polymer network of the hydrogel and one or more biomolecules coupled to the polymer network of the hydrogel, wherein binding between the one or more biomolecular probes and the one or more biomolecules is by non-covalent cross-linking within the polymer network of the hydrogel.

4. The apparatus of claim 3 wherein, if the hydrogel is exposed to the first analyte;
the first analyte competes with the one or more biomolecules for non-covalent cross-linking with the one or more biomolecular probes wherein such competitive non-covalent cross-linking between the biomolecular probes and the first analyte induces a volume change in the hydrogel; and
the volume change induces the deflection from the initial position in the at least one member.

5. The apparatus of claim 1 further comprising one or more biomolecular probes coupled to an outside surface of the member wherein the one or more biomolecular probes are capable of chemically bonding to the first analyte.

6. The apparatus of claim 1 further comprising one or more biomolecular probes coupled to an outside surface of the member wherein the one or more biomolecular probes are capable of chemically bonding to a second analyte.

7. The apparatus of claim 1 further comprising an array of members positioned on a top surface of the substrate.

8. The apparatus of claim 1 further comprising a coating disposed on the top surface of the substrate and an outside surface of the member, wherein the coating is substantially impermeable to: liquid or gas, or combinations thereof and wherein the liquid or gas comprises the first analyte.

9. The apparatus of claim 8 further comprising a package wherein the package is capable of containing the hydrogel wherein the hydrogel is disposed over the substrate.

10. The apparatus of claim 9 wherein the hydrogel is chemically coupled to: the top surface of the substrate, the coating or an inside surface of the package, or combinations thereof.

11. The apparatus of claim 10 wherein the hydrogel is chemically coupled to the top surface of the substrate via a cross-linking agent, wherein the cross-linking agent comprises;
a first layer of polyglycidyl methacrylate (PGMA) partially modified with acrylic acid, coupled to the substrate; and
a second layer of polyacrylamide gel (PAAG) coupled to the substrate via PGMA by photo or thermo initiated in situ radical copolymerization of acrylamide and N,N′-methylene-bisacrylamide.

12. The apparatus of claim 3, wherein the one or more biomolecular probes comprise: antibodies, antibody fragments, single-chain antibodies, genetically engineered antibodies, oligonucleotides, polynucleotides, nucleicacids, nucleic acid analogues, peptide nucleic acids, proteins, peptides, binding proteins, receptor proteins, transport proteins, lectins, substrates, inhibitors, activators, ligands, hormones, neurotranamitters, growth factors or cytokines, or combinations thereof.

13. The apparatus of claim 1, wherein the first analyte comprises a(n): acid, base, organic compound, inorganic chemical, amino acid, peptide, polypeptide, protein, glycoprotein, lipoprotein, antibody, nucleoside, nucleotide, oligonucleotide, nucleic acid, sugar, carbohydrate, oligosaccharide, polysaccharide, fatty acid, lipid, hormone, metabolite, growth factor, cytokine, chemokine, receptor, neurotransmitter, antigen, allergen, antibody, substrate, metabolite, cofactor, inhibitor, drug, pharmaceutical, nutrient, biohazardous agent, infectious agent, prion, vitamin, heterocyclic aromatic compound, carcinogen, mutagen, waste product, virus, bacterium, Salmonella, Streptococcus, Legionella, E. coli, Giardia, Cryptosporidium, Rickettsia, spore, mold, yeast, algae, amoebae, dinoflagellate, unicellular organism, pathogen, prion or a cell, or combinations thereof.

14. A method comprising:
preparing a hydrogel wherein the hydrogel is sensitive to an analyte, wherein the hydrogel exhibits a volume change upon exposure to the analyte;
immersing a member in the hydrogel, wherein the member is capable of detecting mechanical stress induced by the volume change;
exposing the hydrogel to the analyte and inducing mechanical stress on the member; and
detecting the presence of the analyte based at least in part on detection of mechanical stress in the member.

15. The method of claim 14 wherein the volume change in the hydrogel is proportional to a diffusion gradient of the analyte.
